(19) United States
(12) Patent Application Publication
(10) Pub. No.: US 2007/0092289 A1
(43) Pub. Date: Apr. 26, 2007

(54) Image forming apparatus

(75) Inventors: Yuki Nagamori, Ebina-shi (JP); Kenji Inoue, Minamiashigara-shi (JP); Yusuke Kitagawa, Saitama-shi (JP); Masato Serizawa, Ebina-shi (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/476,790

(22) Filed: Jun. 29, 2006

(30) Foreign Application Priority Data
Oct. 21, 2005 (JP) 2005-307569

(51) Int. Cl. G03G 15/02

(52) U.S. Cl. 399/100; 399/176

(57) ABSTRACT

An image forming apparatus includes a charge roll which charges a body to be charged by contact charge, and a roll-like sponge member which is supported such that it comes into contact with a surface of the charge roll and which is rotated together with the charge roll. The roll-like sponge member and the charge roll have physical characteristics such that a surface of the charge roll is scraped away by contact with the roll-like sponge member.

### CROSS-REFERENCE TO RELATED APPLICATION

This application claims priority under 35 USC 119 from Japanese Patent Application No. 2005-307569, the disclosure of which is incorporated by reference herein.

### BACKGROUND

1. Technical Field

The present invention relates to an image forming apparatus such as copiers and printers employing an electrophotographic system, and more particularly, to an image forming apparatus having a contact charge type charge roll which charges a surface of an image bearing member while coming into contact with the rotating image bearing member and rotating, and a cleaning member of the charge roll.

2. Related Art

Conventionally, as a charging device of an image forming apparatus such as copiers and printers employing an electrophotography system, devices utilizing corona discharge phenomenon such as a scorotron charging device are frequently used, but in the case of a charging device utilizing the corona discharge phenomenon, there is a problem that ozone or nitrogen oxide, which adversely affect the human body or the global environment, are generated. On the other hand, a contact charge type system in which a conductive charge roll is brought into direct contact with the image bearing member to charge the image bearing member has become mainstream in recent years because this system can greatly reduce the amount of ozone or nitrogen oxide generated, and power supply efficiency is also excellent.

According to such a contact charge type charging device, since the charge roll is always in contact with the image bearing member, there is a problem that the surface of the charge roll is contaminated due to adhesion of foreign matter. The surface of the image bearing member on which the image forming operation is repeated is subjected to a cleaning step for eliminating foreign matter such as toner which remains after a transfer step, and then, the surface enters the charging step area. However, even if the surface is subjected to the cleaning step, fine particles which are smaller than toner such as portions of the toner or external additives of toner are not cleaned and remain on the image bearing member, and are adhered to the surface of the charge roll. Foreign matter adhered to the surface of the charge roll generates unevenness in the surface resistance of the charge roll, generates abnormal electric discharge or unstable electric discharge and deteriorates the charging uniformity.

### SUMMARY

An image forming apparatus of one aspect of the invention is provided. The image forming apparatus includes: a charge roll that charges a body to be charged by contact charge, and a roll-like sponge member that is supported such that it comes into contact with a surface of the charge roll and that is rotated together with the charge roll, wherein the roll-like sponge member and the charge roll have physical characteristics such that a surface of the charge roll is scraped away by contact with the roll-like sponge member.

### BRIEF DESCRIPTION OF THE DRAWINGS

Exemplary embodiments of the present invention will be described in detail based on the following figures, wherein;

FIG. 1 is a schematic block diagram showing an image forming apparatus according to a first exemplary embodiment of the invention;

FIG. 2 is an enlarged view showing a structure around a charge roll and a sponge member used in the image forming apparatus of the first exemplary embodiment of the invention;

FIG. 3 is a graph showing a relation of a cleaning ability and a surface micro hardness of an charging layer of a charge roll;

FIG. 4 is a graph showing a relation between the cleaning ability and an elastic modulus of the charging layer of the charge roll; and

FIGS. 5A to 5C are photomicrographs showing a scraping state of the charging layer of the charge roll when the charge roll is rotated predetermined times, wherein FIG. 5A shows an initial state, FIG. 5B shows a state where the charge roll has been rotated 500 k cycles, and FIG. 5C shows a state where the charge roll has been rotated 1M cycles.

### DETAILED DESCRIPTION

An image forming apparatus of the present invention will be explained based on the drawings.

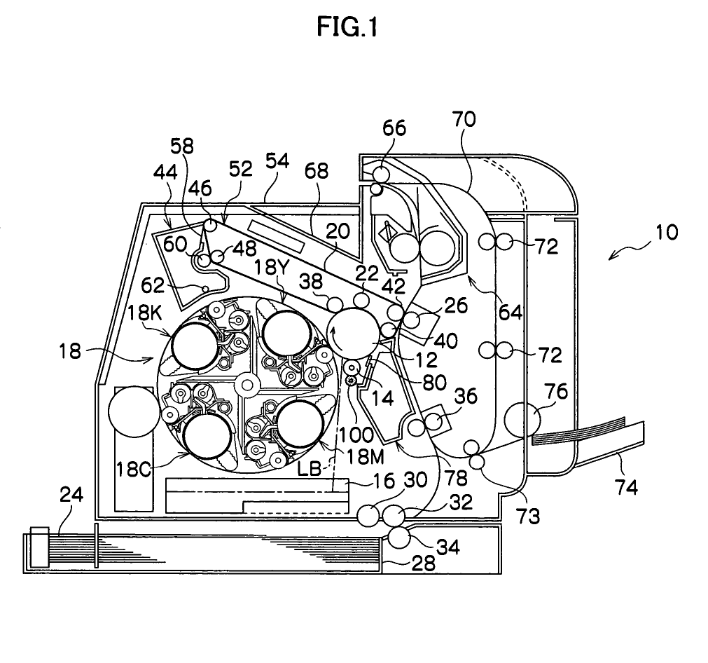

FIG. 1 shows a 4 cycle type full color image forming apparatus 10 according to a first exemplary embodiment. A photosensitive drum 12 is rotatably disposed in the image forming apparatus 10 at slightly right and upper location with respect to a central portion of the image forming apparatus 10. A conductive cylindrical body having a diameter of about 47 mm is used as the photosensitive drum 12. A surface of the conductive cylindrical body is coated with a photosensitive layer made of OPC (organic photoconductor) or the like. The photosensitive drum 12 is rotated by a motor (not shown) at process speed of about 150 mm/sec along a direction of arrow.

A surface of the photosensitive drum 12 is electrified to a predetermined potential by a charge roll 14 disposed substantially directly below the photosensitive drum 12. Then, the photosensitive drum 12 is subjected to image exposure by laser beam LB by an exposing apparatus 16 disposed below the charge roll 14, and an electrostatic latent image corresponding to image information is formed.

An electrostatic latent image formed on the photosensitive drum 12 is developed by a rotary developing device 18, and becomes predetermined colored toner image. In the rotary developing device 18, developing devices 18Y, 18M, 18C and 18K for the respective colors of yellow (Y), magenta (M), cyan (C) and black (K) are disposed along a circumferential direction.

At that time, a surface of the photosensitive drum 12 is subjected to charging, exposing and developing steps in accordance with colors of an image to be formed, and the steps are repeated predetermined times. In the developing step, the rotary developing device 18 is rotated, and the developing devices 18Y, 18M, 18C and 18K of corresponding color move to developing positions opposed to the photosensitive drum 12.

For example, the surface of the photosensitive drum 12 is subjected to the charging, exposing and developing steps four times in correspondence with the respective colors of yellow (Y), magenta (M), cyan (C) and black (K), and toner images are sequentially formed in correspondence with the respective colors of yellow (Y), magenta (M), cyan (C) and black (K) on the surface of the photosensitive drum. When forming the toner image, the number of rotations of the photosensitive drum 12 is varied in accordance with a size of the image. For example, when the size is A4, one image is formed by rotating the photosensitive drum 12 three times. That is, toner images corresponding to the respective colors, i.e., yellow (Y), magenta (M), cyan (C) and black (K) are formed on the surface of the photosensitive drum 12 with each three rotations of the photosensitive drum 12.

The toner images of yellow (Y), magenta (M), cyan (C) and black (K) which are sequentially formed on the photosensitive drum 12 are transferred in a state in which they are superposed on the intermediate transfer belt 20 at a primary transfer position where the intermediate transfer belt 20 is wound around an outer periphery of the photosensitive drum 12, by a primary transfer roll 22.

Toner images of yellow (Y), magenta (M), cyan (C) and black (K) which are multiply-transferred to the intermediate transfer belt 20 are collectively transferred on a recording paper 24 which is fed at predetermined timing, by a secondary transfer roll 26.

The recording papers 24 are fed out by a pick-up roll 30 from a paper feeding cassette 28 disposed at a lower portion of the image forming apparatus 10 and are supplied in a state in which the recording papers 24 are separated one by one by a feed roll 32 and a retard roll 34, and the recording papers 24 are transferred to a secondary transfer position of the intermediate transfer belt 20 in synchronization with toner images transferred to the intermediate transfer belt 20 by a resist roll 36.

The intermediate transfer belt 20 is tightly stretched at predetermined tension by a wrap-in roll 38 which specifies a wrap position of the intermediate transfer belt 20 at upstream side in a rotating direction of the photosensitive drum 12, a primary transfer roll 22 which transfers a toner image formed on the photosensitive drum 12 to the intermediate transfer belt 20, a wrap-out roll 40 which specifies a wrap position of the intermediate transfer belt 20 at downstream side of the wrap position, a backup roll 42 which abuts against the secondary transfer roll 26 via the intermediate transfer belt 20, a first cleaning backup roll 46 which is opposed to the cleaning device 44 of the intermediate transfer belt 20 and a second cleaning backup roll 48. The intermediate transfer belt 20 is driven in a circulation manner at predetermined process speed (about 150 mm/sec) when the photosensitive drum 12 rotates.

Here, the intermediate transfer belt 20 is formed in such a manner that a cross section shape thereof when it is tightly stretched becomes a flat, long and thin substantially trapezoidal shape so as to reduce the image forming apparatus 10 in size.

The intermediate transfer belt 20 integrally constitutes an image forming unit 52 together with the photosensitive drum 12, the charge roll 14, the intermediate transfer belt 20, a plurality of rolls 22, 38, 40, 42, 46 and 48 by which the intermediate transfer belt 20 is tightly stretched, a cleaning device 44 for the intermediate transfer belt 20, and a later-described cleaning device 78 for the photosensitive drum 12. Thus, if an upper cover 54 of the image forming apparatus 10 is opened and a handle (not shown) provided on an upper portion of the image forming unit 52 is manually brought up, the entire image forming unit 52 can be detached from the image forming apparatus 10.

The cleaning device 44 of the intermediate transfer belt 20 includes a scraper 58 which is disposed so as to abut against the surface of the intermediate transfer belt 20 which is tightly stretched by the first cleaning backup roll 46, and a cleaning brush 60 which is disposed so as to come into contact, under pressure, with the surface of the intermediate transfer belt 20 stretched by the second cleaning backup roll 48. Remaining toner and paper powder removed by the scraper 58 and the cleaning brush 60 are collected in the cleaning device 44.

The cleaning device 44 is disposed such that it can oscillate around an oscillating shaft 62 in the counterclockwise direction. The cleaning device 44 is retreated to a position away from the surface of the intermediate transfer belt 20 until the secondary transfer of the toner image of the last color is completed, and if the secondary transfer of the toner image of the last color is completed, the cleaning device 44 abuts against the surface of the intermediate transfer belt 20.

The recording paper 24 on which the toner image is transferred from the intermediate transfer belt 20 is transferred to a fixing device 64, the toner image is heated and pressurized by the fixing device 64 and the toner image is fixed onto the recording paper 24. Then, in the case of one-sided copy (simplex copy), the recording paper 24 on which the toner image is fixed is ejected as it is onto an ejection tray 68 provided at an upper portion of the image forming apparatus 10 by the ejection roll 66.

In the case of double-sided copy (duplex copy), a recording paper 24 having a first surface (front surface) on which a toner image is fixed by the fixing device 64 is not ejected as it is onto the ejection tray 68 by the ejection roll 66, the ejection roll 66 is reversely rotated in a state in which a rear end of the recording paper 24 is sandwiched by the ejection roll 66, the transfer passage for the recording paper 24 is switched to a double-sided copy paper transfer passage 70, the recording paper 24, in a state in which the recording paper 24 is turned over, is transferred by a transfer roll 72 disposed on the double-sided copy paper transfer passage 70 to the secondary transfer position of the intermediate transfer belt 20 again, and a toner image is transferred to a second surface (back surface) of the recording paper 24. The toner image on the second surface (back surface) of the recording paper 24 is fixed by the fixing device 64, and the recording medium 24 is ejected onto the ejection tray 68.

A manual feeding tray 74 can optionally be mounted on a side surface of the image forming apparatus 10 such that the manual feeding tray 74 can open and close. Recording papers 24 having arbitrary size and kind placed on the manual feeding tray 74 are fed by the paper feeding roll 76, and transferred to the secondary transfer position of the intermediate transfer belt 20 through a transfer roll 73 and a resist roll 36 so that an image can be formed on a recording paper 24 of arbitrary size and kind.

From the surface of the photosensitive drum 12 after the transfer step of the toner image is completed, remaining toner and paper powder are removed per rotation of the photosensitive drum 12 by a cleaning blade 80 of the cleaning device 78 disposed diagonally below the photosensitive drum 12, so that the image forming apparatus is ready for the next image forming step.

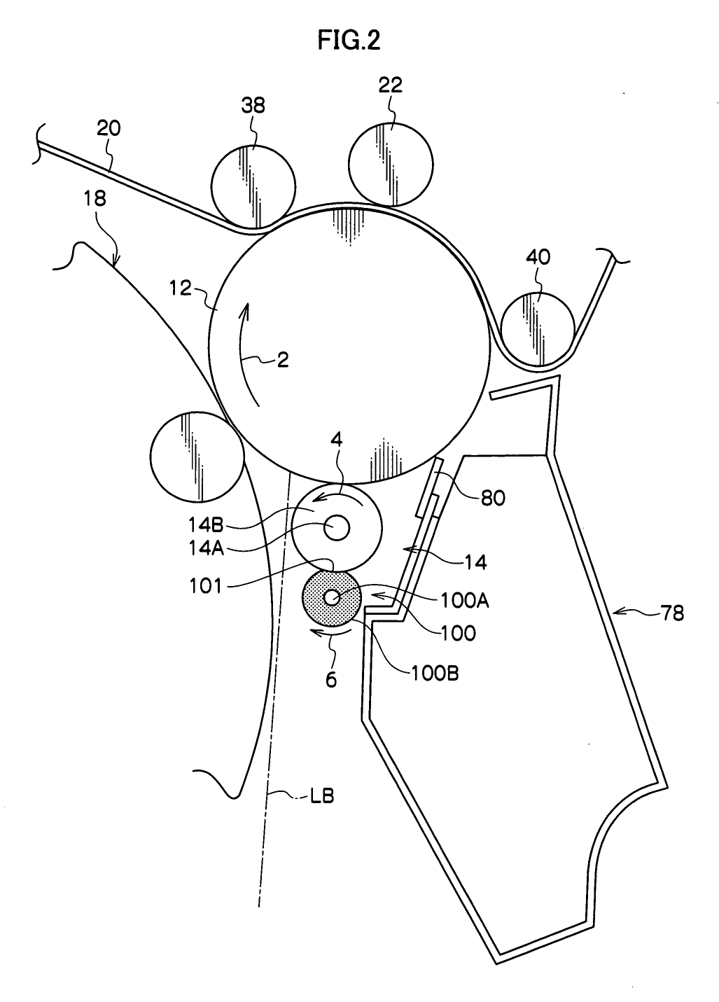

As shown in FIG. 2, the charge roll 14 is disposed at a lower portion of the photosensitive drum 12 such that the charge roll 14 is in contact with the photosensitive drum 12. The charge roll 14 is formed with an charging layer 14B around a conductive shaft 14A. The shaft 14A is rotatably supported. A roll-like sponge member 100 which comes into contact with a surface of the charge roll 14 is provided at a lower portion of the charge roll 14 on the opposite side from the photosensitive drum 12. The sponge member 100 is formed with a sponge layer 100B around the shaft 100A, and the shaft 100A is rotatably supported.

The sponge member 100 is pressed by the charge roll 14 under a predetermined load, the sponge layer 100B is elastically deformed along a peripheral surface of the charge roll 14, and a nip portion 101 is formed. The photosensitive drum 12 is rotated in the clockwise direction in FIG. 2 (direction of arrow 2) by a motor (not shown), and the charge roll 14 is rotated in the direction of arrow 4 by rotation of the photosensitive drum 12. The roll-like sponge member 100 is rotated in the direction of arrow 6 by rotation of the charge roll 14.

If the sponge member 100 is rotated by rotation of the charge roll 14, contaminations such as toner or external additive on the surface of the charge roll 14 are cleaned by the sponge member 100. The charge roll 14 and the sponge member 100 have physical properties for scraping away the surface of the charge roll 14 by contact with the sponge member 100. The physical properties are obtained by adjusting the material of the charge roll 14, surface micro hardness and elastic modulus as well as by adjusting material of the sponge member 100, the number of cells of the foam and a compression amount into the charge roll 14. The physical properties will be described later.

Next, the sponge member 100 will be explained.

Free-machining steel, stainless steel or the like is used as the material of the shaft 100A of the sponge member 100. Materials and surface processing method are appropriately selected in accordance with usage such as sliding properties. Concerning material having no conductivity, processing for making the material conductive may be carried out by employing general processing such as plating, or the material having no conductivity may be used as it is of course. The sponge member 100 comes into contact with the charge roll 14 through the sponge layer 100B under appropriate nip pressure. Thus, material having strength which is not bent at the time of nipping or a shaft diameter having sufficient rigidity with respect to shaft length is selected.

The sponge layer 100B composes of porous foam having three dimensional structure. The material of the sponge layer 100B is selected from foam resin or rubber material such as polyurethane, polyethylene, polyamide, olefin, melamine or polypropylene, NBR, EPDM, natural rubber and styrene butadiene rubber, chloroprene, silicone and nitrile. As the material of the sponge layer 100B, polyurethane having high tear strength and high tensile strength is especially preferably used because foreign matter such as external additive can effectively be removed, flaw is not formed on the surface of the charge roll 14 by the rubbing with respect to the sponge layer 100B and the sponge layer 100B is not scattered or damaged for long term use.

The polyurethane is not especially limited only if it causes reaction between polyol such as polyester polyol, polyether polyester and acrylic polyl, and isocyanate such as 2,4-tolylene diisocyanate, 2,6-tolylene diisocyanate and 4,4-diphenylmethane diisocyanate, tolidine diisocyanate, 1,6-hexamethylene diisocyanate. It is preferable that chain elongating agent such as 1,4-butanediol and trimethylol propane is mixed. It is general.that the polyurethane is foamed using foaming agent such as azo compound such as water, azodicarbonamido and azobisisobutyronitrile. Auxiliaries such as foaming assistant, form adjusting agent and catalyst may be added if necessary.

To maintain the stable cleaning ability for a long term, foreign matter such as external additive and toner adhered to the charge roll 14 is taken into the cell of the foam of the sponge member 100, and when the foreign matter collected in the cell is flocculated and reaches an appropriate size, the foreign matter is returned to the photosensitive drum 12 from the sponge member 100 via the charge roll 14, the foreign matter is collected to the cleaning device 78 which cleans the photosensitive drum 12, and the cleaning ability is maintained.

Thus, it is preferable that the number of cells of the sponge member 100 is 40 to 80/25 mm (40 to 80 per 25 mm), and more preferably 45 to 75/25 mm (45 to 75 per 25 mm). By setting the number of cells to this value, it becomes easy to take in the foreign matter such as external additive, and to move the taken foreign matter such as external additive to the charge roll 14 and the photosensitive drum 12. If the number of cells is higher than 80/25 mm, since the cell diameter is small, the taking-in ability of the external additive is lowered, and if the number of cells is smaller than 40/25 mm, the cell diameter becomes excessively large, and it becomes difficult to solidify the taken external additive to an appropriate size suitable for moving the same to the charge roll 14.

It is preferable that the diameter of the sponge member 100 is in a range of φ8 mm to φ15 mm, more preferably φ9 mm to φ14 mm, and the thickness of the sponge layer 100B is in a range of 2 mm to 4 mm. If the diameter is equal to or greater than 15 mm, the number of times one peripheral surface of the sponge member 100 comes into contact with the external additive is reduced, and the number of cleaning operations is reduced and thus, although the cleaning ability is stabilized for a long term but the image forming apparatus can not be reduced in size. If the diameter is equal to or smaller than 9 mm, this is preferable because the image forming apparatus can be reduced in size, but since the number of times the one peripheral surface comes into contact with the external additive is increased and the number of cleaning operations is increased, this is not preferable for long term stability.

It is preferable that the compression amount of the sponge member 100 into the charge roll 14 is in a range of 10% to 60% of the thickness of the sponge member 100, and more preferably, in a range of 20% to 50%. By setting the compression amount to such a range, appropriate nip width and nip pressure can be obtained, and it becomes easy to finely scrape away the surface of the charge roll 14. If the compression amount is smaller than 10%, the nip width and the nip pressure are not sufficient, and the charge roll 14 can not be scraped away finely. If the compression amount is greater than 60%, the sponge member 100 can not be brought into contact with the charge roll 14 under pressure stably, and the surface of the charge roll 14 can not be scraped away uniformly.

It is preferable that polishing powder made of external additive added to the toner is included in the sponge layer 100B. As the polishing powder, SeO₂ is used. If such polishing powder is included in the sponge layer 100B, it becomes easy to finely scrape away the surface of the charge roll 14 by the sponge member 100.

Next, the charge roll 14 will be explained.

The charge roll 14 is formed by sequentially forming a conductive elastic layer and a surface layer as the charging layer 14B on the conductive shaft 14A.

The surface micro hardness of the charging layer 14B of the charge roll 14 is preferably 0.35 or higher and 20.0 or lower, and more preferably 0.40 or higher and 10.0 or lower. Here, the surface micro hardness means hardness of several μm of the surface is measured, and the surface micro hardness is physical property which is influenced by varying the surface layer material of the charge roll 14.

The surface micro hardness can be obtained by measuring the entering depth of a pad into a sample instead of obtaining a diagonal line of a dip like Vickers hardness which is widely used for measuring hardness of metal material. When a test load is defined as P(mN) and an entering amount of pad to a sample (pushing depth) is defined as D(μm), the surface micro hardness DH is defined in the following equation (1).
DH=αP/D² Equation (1)

wherein, a represents a constant by a pad shape, and α=3.8584 (pad to be used: triangular pyramid pad).

The surface micro hardness represents hardness obtained from the load in the process of pushing the pad into the sample and the pushing depth, and the surface micro hardness represents not only the plastic deformation of the sample but also the strength characteristics of a material including the elastic deformation. The measuring area is very small, and it is possible to precisely measure the hardness in a range close to toner particle diameter.

The surface micro hardness of the charging layer 14B of the charge roll 14 is measured using a super micro hardness meter DUH-201S (made by Shimadzu Corporation).

The measuring conditions are as follows:

Measuring environment: 23° C., 55% RH

Pad used: triangular pyramid pad

Test mode: 3 (soft material test)

Test load: 0.70 gf

Load speed: 0.0145 gf/sec

Holding time: 5 sec.

By setting the surface micro hardness of the charging layer 14B of the charge roll 14 to the above range, it is possible to finely scrape away the peripheral surface of the charging layer 14B of the charge roll 14 by the sponge member 100 when the sponge member 100 comes into contact with the charge roll 14. If the surface micro hardness is equal to or lower than 0.35, the surface of the charge roll 14 is excessively scraped away, and deviated wearing is generated. If the surface micro hardness is equal to or higher than 20.0, the surface of the charge roll 14 can not be finely scraped away by the sponge member 100.

It is preferable that the diameter of the charge roll 14 is in a range of φ8 mm to φ15 mm, more preferably φ9 to φ14 mm, and the thickness of the charging layer 14B is in a range of 2 mm to 4 mm. If the diameter is equal to or greater than 15 mm, the number of times one peripheral surface comes into contact with external additive is reduced, and the number of discharging operations is reduced and thus, the long term stability with respect to contamination and charging performance is excellent but is inferior in terms of miniaturization. If the diameter is equal to or smaller than 8 mm, the image forming apparatus 10 can be reduced in size but the number of times one peripheral surface comes into contact with external additive is increased, the number of discharging operations is increased, and the long term stability is deteriorated.

The elastic modulus of the charging layer 14B of the charge roll 14 is preferably 8 MPa or higher and 4500 WPa or lower, and more preferably 10 MPa or higher and 3000 MPa or lower. If the elastic modulus is smaller than 8 MPa, stable nip shape can not be formed by pushing the sponge member 100, and the surface of the charge roll 14 can not finely be scraped away. If the elastic modulus is greater than 4500 MPa, the charge roll 14 is largely deformed at the nip portion 101 with the sponge member 100, the cleaning ability is deteriorated, the shape of the nip thereof with the photosensitive drum 12 becomes uneven and thus, charging failure is generated. Here, the elastic modulus was measured by a rheometer produced by Rheometrics Corporation, tradename “RDA2” (RHIOS system ver.4.3) using a parallel plate having a diameter of 8 mm under the conditions of plate interval of 4 mm, frequency of 1 rad/sec, temperature rising speed of 1° C. per minute, measuring temperature range of 40 to 150° C., and maximum 20% of automatic distortion ratio control.

The charge roll 14 is not limited to the following structure only if it has predetermined charging ability of course.

As material of the shaft 14A, free-machining steel or stainless steel is used, material and surface processing method are appropriately selected in accordance with sliding properties and uses. Concerning material having no conductivity, processing for making the material conductive may be carried out using general processing such as plating.

As the conductive elastic layer constituting the charging layer 14B of the charge roll 14, it is possible to add elastic material such as rubber having elasticity, conductive material such as carbon black or ion conductive material which adjust the resistance of the conductive elastic layer, softener, plasticizer, curing agent, vulcanized agent, vulcanizing accelerator, antioxidant, filler such as silica and calcium carbonate, material normally added to rubber. The conductive elastic layer is formed by coating the peripheral surface of the conductive shaft 14A with a mixture to which material which is normally added to rubber is added. As the conducting agent for adjusting the resistant value, it is possible to use agent in which electrically conductive material is dispersed using electron and/or ion as a charge carrier such as conducting agent such as carbon black and ion conducting agent mixed in matrix material. The elastic material may be foam.

The elastic material constituting the conductive elastic layer is formed by dispersing conducting agent into the rubber material for example. Examples of the rubber materials are isoprene rubber, chloroprene rubber, epichlorohydrin rubber, butyl rubber, urethane rubber, silicon rubber, fluorine rubber, styrene butadiene rubber, butadiene rubber, nitrile rubber, ethylene propylene rubber, epichlorohydrin-ethyleneoxide copolymer rubber, epichlorohydrin -ethyleneoxide-allyl glycidyl ether copolymer rubber, ethylene-propylene-diene ternary copolymer rubber (EPDM), acrylo nitrile-butadiene copolymer rubber, natural rubber and mixture thereof Especially, silicone rubber, ethylene propylene rubber, epichlorohydrin-ethyleneoxide copolymer rubber, epichlorohydrin-ethyleneoxide-allyl glycidyl ether copolymer rubber, acrylo-nitrile butadiene copolymer rubber and mixture thereof are preferably used. The rubber material may be foam or non-foam.

Electron conducting agent or ion conducting agent is used as the conducting agent. Examples of the fine powder electron conducting agent are carbon black such as kechen black, acetylene black; pyrolysis carbon, graphite; various conductive metal or alloy such as aluminum, copper, nickel, stainless steel; various conductive metal oxide such as tin oxide, indium oxide, titanium oxide, tin oxide-antimony oxide solid solution, tin oxide-indium oxide solid solution; material obtained by making a surface of insulative material into conductive surface. Examples of the ion conducting agent are perchlorate, chlorate such as tetraethylammonium, lauryltrimethyl ammonium; perchlorate, chlorate of alkaline metal, alkaline earth metal such as lithium, magnesium.

The conducting agent may be used alone or two or more agents may be combined and used in combination. The amount of the conducting agent to be added is not especially limited. In the case of the electron conducting agent, it is preferable that the amount thereof to be added is in a range of 1 to 60 parts by mass with respect to 100 parts by mass of rubber material. In the case of the ion conducting agent, it is preferable that the amount thereof to be added is in a range of 0.1 to 5.0 parts by mass with respect to 100 parts by mass of rubber material.

The surface layer constituting the charging layer 14B is formed to prevent the contamination caused by foreign matter such as toner. Resin, rubber and the like can be used as the material of the surface layer, and the materials are not limited. Examples of such materials are polyester, polyimide, copolymer nylon, silicone resin, acrylic resin, polyvinyl butyral, ethylene tetrafluoro ethylene copolymer, melamine resin, fluorine rubber, epoxy resin, polycarbonate, polyvinyl alcohol, cellulose, polyvinylidene chloride, polyvinyl chloride, polyethylene, ethylene vinyl acetate copolymer.

In view of contamination of the external additive, polyvinylidene-fluoride, 4 ethylene fluoride copolymer, polyester, polyimide and copolymer nylon are preferably used. The copolymer nylon includes one or more of 610 nylon, 11 nylon and 12 nylon as polymerization unit, and examples of other polymerization unit included in this copolymer are 6 nylon and 66 nylon. Here, it is preferable that the ratio in which the polymerization unit including 610 nylon, 11 nylon and 12 nylon is included in the copolymer is 10% by weight or higher in total. If the polymerization unit is equal to or higher than 10%, the liquid adjusting ability and the film forming ability when it is applied to the surface are excellent, wear of the resin layer when it is repeatedly used is small and the amount of foreign matter adhered to the resin layer is small, the durability of the roll is excellent, and variation in characteristics caused by environment is also small.

The high polymer materials may be used alone or two or more materials may be mixed and used in combination. The average molecular weight of the high polymer material is preferably in a range of 1,000 to 100,000, and more preferably in a range of 10,000 to 50,000.

A conductive material can be included in the surface layer and a resistance value can be adjusted. It is preferable that the particle diameter of the conductive material is 3 μm or less.

As a conducting agent for adjusting the resistance value, it is possible to use carbon black or conductive metal oxide particle mixed in matrix material, or agent in which conductive material using electron and/or ion as a charge carrier such as ion conducting agent is dispersed.

Examples of carbon black of conducting agent are “special black 350”, “special black 100”, “special black 250”, “special black 5”, “special black 4”, “special black 4A”, “special black 550”, “special black 6”, “color black FW200”, “color black FW2”, “color black FW2V” which are all produced by Degussa Corporation, and “MONARCH1000”, “MONARCH1300”, “MONARCH1400”, “MOGUL-L” and “REGAL400R” which are all produced by Cabot Corporation.

The carbon black is pH4.0 or less, dispersibilities into resin composite are excellent due to effect of oxygen containing functional group existing on the surface, and if carbon black of pH4.0 or less is mixed, the charging uniformity can be enhanced, and variation of the resistance value can be reduced.

The conductive metal oxide particle which is conductive particle for adjusting the resistance value is conductive particle such as tin oxide, tin oxide doped with antimony, zinc oxide, anatase type titanium oxide and ITO. Any conducting agent can be used only it uses electron as a charge carrier without limitation. These materials can be used alone or two or more can be used in combination. The particle diameter thereof is not limited unless it departs from the scope of the invention. Preferable examples are tin oxide, tin oxide doped with antimony, anatase type titanium oxide in view of the resistance value adjustment and strength, and especially tin oxide and tin oxide doped with antimony are preferable.

If the resistance is controlled using such conductive material, the resistance value of the surface layer is not varied by the environmental condition and stable characteristics can be obtained.

A fluorine-based or silicone-based resin is used as the surface layer. It is preferable that the surface layer includes fluorine denatured acrylate polymer. Fine particles may be added to the surface layer. With this, the surface layer becomes hydrophobic layer and this prevents foreign matter from adhering to the charge roll 14. If insulative particles such as alumina or silica are added to provide the surface of the charge roll 14 with concavities and convexities, a load at the time of rubbing with respect to the photosensitive drum 12 can be reduced and wear resistance of both the charge roll 14 and the photosensitive drum 12 can be enhanced.

According to the image forming apparatus 10, the sponge member 100 comes into contact with the surface of the charge roll 14. In addition to the sponge member 100, it is also possible to provide a polishing paper which comes into contact with the surface of the charge roll 14 or a polishing member in which a cushion properties are enhanced utilizing a elastic resin such as a sponge for a backing plate of the polishing paper. With this, it is possible to finely scrape away the surface of the charge roll 14 stably.

Next, a test for evaluating the cleaning ability of the charge roll 14 of the image forming apparatus 10 will be explained.

Seven samples A to G of the charge rolls 14 whose surface micro hardness of the charging layers 14B are varied as shown in Table 1 are prepared, and test of cleaning ability is carried out. As the surface micro hardness, hardness of several μm of the surface is measured, and the surface micro hardness is physical property which is influenced by varying the surface layer material of the charging layer 14B.

TABLE 1
Charge roll

| Sample | Surface micro hardness |
|---|---|
| A | 0.06 |
| B | 0.29 |
| C | 0.35 |
| D | 0.9 |
| E | 1.25 |
| F | 1.45 |
| G | 1.6 |

As a method for evaluating the cleaning ability, in the image forming apparatus 10 shown in FIG. 1, a print test is carried out in a state where the sponge member 100 is not attached to contaminate the charge roll 14 in advance and then, only the photosensitive drum 12, the charge roll 14 and the sponge member 100 are disposed, the photosensitive drum 12 is rotated a predetermined number of times, and variation of the surface of the charge roll 14 is measured. In the measuring method at that time, variation of white degree caused by external additive adhered to the surface of the charge roll 14 is graded in six levels, wherein 0 represents the best state and 6 represents the worst state.

As materials of the samples A to G of the charge roll 14, fluorine denatured acrylate resin is used as surface layer materials of the samples D, E, F and G having high surface micro hardness, and polyester-based resin is used as surface layer materials of the samples A, B and C having small surface micro hardness, and degree of polymerization and the like are adjusted. As the sponge member 100, urethane foam roll is used.

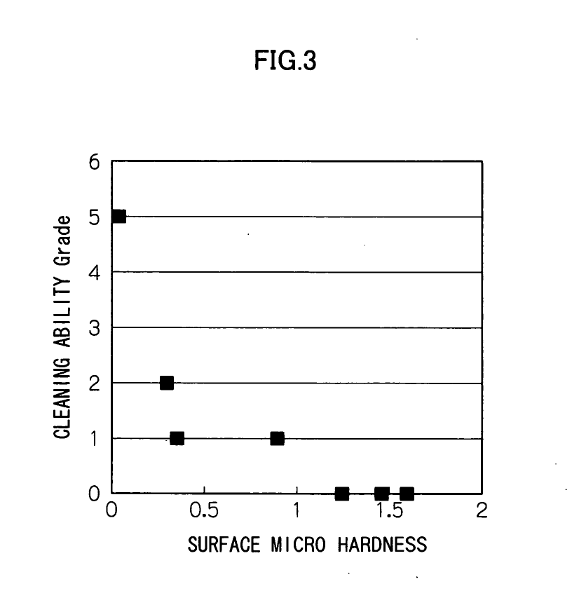

From a result shown in FIG. 3, it can be found that as the surface micro hardness of the charging layer 14B of the charge roll 14 is greater, the cleaning ability is more enhanced. It is found that especially the samples D to G using the fluorine denatured acrylate resin have excellent cleaning ability. From FIG. 3, it is found that the preferable surface micro hardness is in a range of 0.35 to 1.6.

Next, five samples H to L of the charge roll 14 having different elastic modulus are prepared as shown in Table 2, and the same evaluation of the cleaning ability is carried out.

TABLE 2
Charge roll

| Sample | Elastic modulus |
|---|---|
| H | 1 |
| I | 5 |
| J | 8 |
| K | 12 |
| L | 32 |

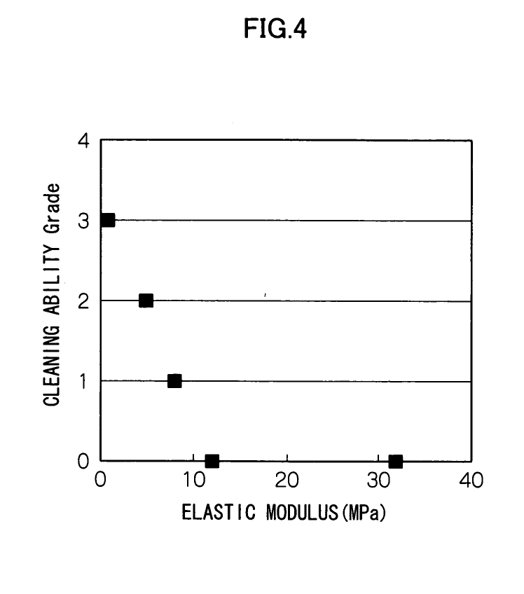

From a result shown in FIG. 4, it can be found that as the elastic modulus is greater, the cleaning ability is more enhanced. This is because that as the elastic modulus is greater, a difference with the elastic modulus of a lower layer of the charge roll 14 becomes greater, the surface layer is prone to be finely splinter, the layer is rubbed by the sponge member 100 which is soft like urethane many times, the surface of the charge roll 14 is scraped away little by little. It is found from FIG. 4 that preferable elastic modulus is in a range of 8 MPa to 32 MPa.

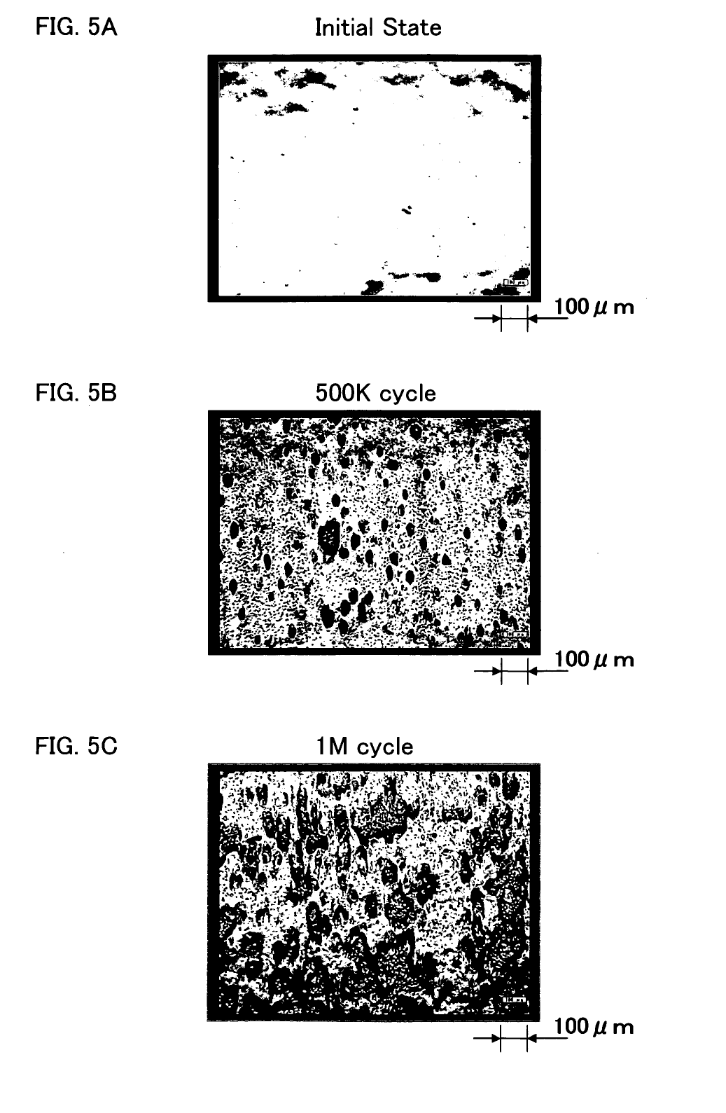

A print test is carried out using the image forming apparatus shown in FIG. 1. As a result, it is confirmed that excellent image is maintained until the photosensitive drum 12 is 1M cycles (1000000 rotations). A surface of the charge roll 14 in an initial state, rotations at 500 k cycles (500000 rotations) during the print test, and after 1M cycles (1000000 rotations) are observed using a microscope (KEYENCE laser microscope VK-8510), and states where the surface of the charge roll 14 is gradually scraped away is observed as shown in FIGS. 5A to 5C. In photomicrographs shown in FIGS. 5A to 5C, scale (100 μm) is shown in lower right blank portions. A wear rate of the surface layer of the charge roll 14 is 2.4 nm/k cycle (surface layer wear rate per 1000 rotations of the charge roll).

With this test, it is confirmed that if the surface of the charge roll 14 is finely scraped away by the sponge member 100, the image forming apparatus 10 can stably be electrified for a long term as long as 1M cycles of a photosensitive drum (about 150000 sheets can be printed).

As described above, in the image forming apparatus 10 of the exemplary embodiment, the cleaning member does not have especially high polishing ability, a polyurethane-based sponge member 100 having low hardness is used and thus, it is possible to stably polish the surface of the charge roll 14 over a long term. Since the sponge member 100 has the cell structure, the surface layer of the finely scraped charge roll 14 is solidified into a certain size in the cell together with the external additive adhered to the surface of the charge roll 14, and the surface layer is returned onto the photosensitive drum 12 through the charge roll 14, and is collected by the rotary developing device 18, the intermediate transfer belt 20, the cleaning device 78 and the cleaning device 44. Therefore, the cleaning ability can be maintained stably without being clogged. Thus, the charge roll 14 can uniformly be electrified over five times longer as compared with the conventional technique.

The materials of the charge roll 14 and the sponge member 100 are not limited those described above. Materials can appropriately be selected only if it can finely scrape away the surface of the charge roll by the roll-like sponge member.

In the exemplary embodiment, the charge roll 14 comes into contact with a lower portion of the photosensitive drum 12, and the sponge member 100 comes into contact with a lower portion of the charge roll 14. The invention is not limited to this structure. For example, the charge roll may come into contact with an upper portion of the photosensitive drum and the sponge member may come into contact with an upper portion of the charge roll.

In the image forming apparatus 10 of the exemplary embodiment, the formation of a toner image on the photosensitive drum 12 using the rotary developing device 18 is repeated by four cycles. The invention is not limited to this structure. For example, even when image forming units of yellow, magenta, cyan and black are arranged along a moving direction of the intermediate transfer belt, the invention can be applied to the photosensitive drum, the charge roll and the roll-like sponge member of each image forming unit.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a charge roll that charges a body to be charged by contact charge, and a roll-like sponge member that is supported such that it comes into contact with a surface of the charge roll and that is rotated together with the charge roll,
wherein
the roll-like sponge member and the charge roll have physical characteristics such that a surface of the charge roll is scraped away by contact with the roll-like sponge member.

2. The image forming apparatus according to claim 1, wherein the physical characteristics include the surface micro hardness of the charge roll and the number of cells of the roll-like sponge member, and the surface micro hardness of the charge roll is set to from 0.35 to 20.0, and the number of cells of the roll-like sponge member is set to from 40 to 80 per 25 mm.

3. The image forming apparatus according to claim 1, wherein the physical characteristics include the elastic modulus of the surface of the charge roll, and the elastic modulus of the surface of the charge roll is set from 8 MPa to 4500 MPa.

4. The image forming apparatus according to claim 1, wherein the physical characteristics include a compression amount of the roll-like sponge member into the charge roll, and the compression amount is set from 10% to 60% of thickness of the roll-like sponge member.

5. The image forming apparatus according to claim 1, wherein the physical characteristics include a material of the roll-like sponge member, and the roll-like sponge member is made of a urethane-based resin or a foam made of a rubber material.

6. The image forming apparatus according to claim 1, wherein the physical characteristics include a material of a surface layer of the charge roll, and the surface layer of the charge roll includes a fluorine denatured acrylate polymer.

7. The image forming apparatus according to claim 1, further comprising a polishing member that abuts against the charge roll.

8. The image forming apparatus according to claim 1, wherein the roll-like sponge member includes polishing powder comprising an external additive added to a toner.

9. The image forming apparatus according to claim 8, wherein the polishing powder is SeO₂.

10. A image forming apparatus comprising:
a charge roll that contacts and charges a surface of a photosensitive member on which a toner image is formed, and
a roll-like foam that contacts a surface of the charge roll, the roll-like foam being supported such that a nip is formed between the roll-like foam and the charge roll, and rotated by rotation of the charge roll, wherein
the charge roll and the roll-like foam have predetermined physical characteristics, whereby deposited matter on the surface of the charge roll is taken into cells of the roll-like foam by contact with the charge roll and then, the deposited matter is flocculated on the foam and is moved back to the surface of the photosensitive member via the charge roll.

11. The image forming apparatus according to claim 10, wherein the physical characteristics include the surface micro hardness of the charge roll and the number of cells of the roll-like foam, the surface micro hardness of the charge roll is set from 0.35 to 20.0, and the number of cells of the roll-like foam is set from 40 to 80 per 25 mm.

12. The image forming apparatus according to claim 10, wherein the physical characteristics include the elastic modulus of the surface of the charge roll, and the elastic modulus of the surface of the charge roll is set from 8 MPa to 4500 MPa.

13. The image forming apparatus according to claim 10, wherein the physical characteristics include a compression amount of the roll-like foam into the charge roll, and the compression amount is set from 10% to 60% of thickness of the roll-like foam.

14. The image forming apparatus according to claim 10, wherein the physical characteristics include a material of the roll-like foam, and the roll-like foam is made of a urethane-based resin or a foam made of a rubber material.

15. The image forming apparatus according to claim 10, wherein the physical characteristics include a material of a surface layer of the charge roll, and the surface layer of the charge roll includes a fluorine denatured acrylate polymer.

16. The image forming apparatus according to claim 10, further comprising a polishing member that abuts against the charge roll.

17. The image forming apparatus according to claim 10, wherein the roll-like foam includes polishing powder made of an external additive added to a toner.

18. The image forming apparatus according to claim 8, wherein the polishing powder is SeO₂.
